(19) United States
(12) Patent Application Publication
(10) Pub. No.: US 2026/0298785 A1
(43) Pub. Date: Oct. 1, 2026

(54) TEMPERATURE CONTROL DEVICE FOR TRIAXIAL LOADING EXPERIMENT AND METHOD THEREOF, AND TRIAXIAL LOADING EXPERIMENT DEVICE

(71) Applicant: Jilin University, Changchun City (CN)

(72) Inventors: Hongwei ZHAO, Changchun City (CN); Ruitao MA, Changchun City (CN); Jingchun MA, Changchun City (CN); Shuangwei MA, Changchun City (CN); Shizhong ZHANG, Changchun City (CN); Hang ZHU, Changchun City (CN); Changyi LIU, Changchun City (CN); Peng LIU, Changchun City (CN); Futao HE, Changchun City (CN); Jiucheng ZHAO, Changchun City (CN); Wei LIAO, Changchun City (CN); Minghao RONG, Changchun City (CN); Wei CAO, Changchun City (CN); Zelin LU, Changchun City (CN); Panxue ZHAO, Changchun City (CN)

(21) Appl. No.: 19/218,302

(22) Filed: May 25, 2025

(30) Foreign Application Priority Data
Mar. 27, 2025 (CN) 202510376480.X

(51) Int. Cl. G01N 3/04; G01N 23/02

(52) U.S. Cl. CPC G01N 3/04; G01N 23/025; G01N 2203/0226; G01N 2203/0242; G01N 2203/0256; G01N 2223/1016; G01N 2223/106; G01N 2223/3106; G01N 2223/317

(57) ABSTRACT

A temperature control device for a triaxial loading experiment and a method thereof, and a triaxial loading experiment device are provided, which relate to the technical field of triaxial loading experiments. The temperature control device for the triaxial loading experiment includes a gas processing and conveying device and a control module. The gas processing and conveying device is configured to heat a gas medium and input the processed gas medium into an experimental cavity. The control module is communicated with the gas processing and conveying device, controls the gas processing and conveying device to continuously input the gas medium for temperature adjustment into the experimental cavity, adjusts the temperature of the gas medium to allow a target area in the experimental cavity to reach thermal balance.

### CROSS-REFERENCE TO RELATED PRESENT DISCLOSURE

This patent application claims the benefit and priority of Chinese Patent Application No. 202510376480.X filed with the China National Intellectual Property Administration on Mar. 27, 2025, the disclosure of which is incorporated by reference herein in its entirety as part of the application.

### TECHNICAL FIELD

The present disclosure relates to the technical field of triaxial loading experiments, and in particular to a temperature control device for a triaxial loading experiment and a method thereof, and a triaxial loading experiment device.

### BACKGROUND

With the rapid development of the modern industry, various materials and structures have been applied to more and more complex service environments. How to correctly evaluate the performance of materials and structures under a multi-field coupling condition is an urgent scientific topic. Therefore, an experimental device that can accurately control the temperature and simultaneously apply multi-axial loads is required. This is of great significance to the safety and the reliability of many fields such as aerospace, energy and transportation.

In the current temperature control system, in view of the mechanical properties of materials and structures under multi-field coupling conditions, the traditional experimental methods directly control the temperature of the experimental environment by means of resistance wires and liquid nitrogen, so that it is difficult to achieve precise temperature control, uniform temperature field distribution and continuous temperature change from high temperature to low temperature and from low temperature to high temperature.

### SUMMARY

The present disclosure aims to provide a temperature control device for a triaxial loading experiment and a method thereof, and a triaxial loading experiment device, so as to solve the problems in the prior art and enable precise temperature control, uniform temperature field distribution, and continuous temperature change.

In order to achieve the above objectives, the present disclosure provides the following scheme

The present disclosure provides a temperature control device for a triaxial loading experiment, including: a gas processing and conveying device and a control module. The gas processing and conveying device is configured to heat a gas medium and input the processed gas medium into an experimental cavity. The control module is communicated with the gas processing and conveying device, controls the gas processing and conveying device to continuously input the gas medium for temperature adjustment into the experimental cavity, adjusts the temperature of the gas medium to allow a target area in the experimental cavity to reach thermal balance, and then adjusts a flow rate of the input gas medium to allow a temperature gradient of the target area to reach a set threshold range.

Preferably, the gas processing and conveying device includes a gas input pipe, a gas source and a heater, an end of the gas input pipe is communicated with the experimental cavity, and another end thereof is communicated with the gas source, the heater heats the gas medium before being input into the experimental cavity, the gas source supplies the gas medium to the gas input pipe, and the control module is communicated with the heater and the gas source to control a heating power of the heater and a supply flow rate of the gas source.

Preferably, the gas sources comprises two gas sources, namely a liquid nitrogen tank and an air pump, the liquid nitrogen tank supplies low-temperature nitrogen to the gas input pipe, and the air pump supplies normal-temperature air to the gas input pipe.

Preferably, the liquid nitrogen tank is communicated with the gas input pipe through a nitrogen branch, the air pump is communicated with the gas input pipe through an air branch, the air branch is provided with a one-way valve, an exhaust port of the liquid nitrogen tank or the nitrogen branch is provided with an exhaust valve with adjustable opening, and both the air pump and the exhaust valve are communicated with the control module.

Preferably, the temperature control device for the triaxial loading experiment further includes a plurality of temperature sensors, wherein the plurality of temperature sensors are provided at different directions in the target area, respectively.

Preferably, the temperature control device for the triaxial loading experiment further includes a gas guide plate, wherein the gas guide plate is provided in the experimental cavity and opposite to an air inlet of the experimental cavity, and a gap is provided between the gas guide plate and the air inlet.

The present disclosure further provides a triaxial loading experimental device, including structural members enclosing an experimental cavity and the temperature control device for the triaxial loading experiment as described above.

Preferably, the structural members include a middle cavity assembly, an upper cover assembly and a lower cover assembly; the middle cavity assembly is in a form of a sleeve structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

The present disclosure further provides a temperature control method for a triaxial loading experimental cavity, including:
continuously inputting a gas medium for temperature adjustment into an experimental cavity, adjusting the temperature of the gas medium to allow a target area in the experimental cavity to reach thermal balance, and then adjusting a flow rate of the input gas medium to allow a temperature gradient of the target area to reach a set threshold range.

Preferably, the temperature control method for the triaxial loading experimental cavity further includes: a step of calibrating a temperature gradient in a cavity: providing six temperature sensors in a target area, and arranging the six temperature sensors in six orientations, respectively; continuously inputting a gas medium for temperature adjustment into an experimental cavity, adjusting the temperature of the gas medium to allow a target area in the experimental cavity to reach thermal balance, and then adjusting a flow rate of the input gas medium to allow a temperature gradient of the target area to reach a set threshold range, and recording the gas flow rate at this time as a first gas flow rate;
a step of controlling the temperature precisely: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range;
a step of continuously changing the temperature from high temperature to low temperature: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range; wherein the gas medium in this step is nitrogen;
a step of continuously changing the temperature from low temperature to high temperature: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range; wherein the gas medium in this step is air.

Compared with the prior art, the present disclosure has the following technical effects.

According to the scheme provided by the present disclosure, the gas medium for temperature adjustment is input into the experimental cavity to adjust the temperature of the experimental cavity. The gas medium input into the experimental cavity is fast in diffusion speed and low in energy transfer delay under the action of the precursor force, so that the temperature gradient is small and the temperature is uniform. In addition, in the scheme provided by the present disclosure, both the temperature reduction and the temperature increase are achieved by the method of inputting the gas medium. The same device and control module are used, so that the control process is consistent, the delay is low, the temperature adjustment efficiency and the quality are improved, and continuous temperature change is enabled.

### BRIEF DESCRIPTION OF THE DRAWINGS

In order to explain the embodiments of the present disclosure or the technical schemes in the prior art more clearly, the drawings that need to be used in the embodiments will be briefly introduced hereinafter. Obviously, the drawings in the following description are only some embodiments of the present disclosure. For those skilled in the art, other drawings can be obtained according to these drawings without paying creative labor.

FIG. 1 is a partial schematic structural diagram of a triaxial loading experimental device according to an embodiment of the present disclosure.

FIG. 2 is an exploded view of a structure of FIG. 1.

FIG. 3 is a schematic structural diagram of a cavity assembly, a gas medium temperature adjusting assembly and a gas guide plate of a transmitting part in FIG. 1.

FIG. 4 is a cross-sectional view of FIG. 3.

FIG. 5 is a schematic structural diagram of a cavity assembly of a receiving part in FIG. 1.

FIG. 6 is a cross-sectional view of FIG. 5.

FIG. 7 is a schematic structural diagram of a lower cover assembly.

FIG. 8 is a schematic structural diagram of a gas medium temperature adjusting assembly.

FIG. 9 is an exploded view of a structure of FIG. 8.

FIG. 10 is a schematic structural diagram of a tee.

FIG. 11 is an exploded view of a structure of a heater.

FIG. 12 is a schematic structural diagram when six temperature sensors are provided on a temperature sensor support frame.

FIG. 13 is a schematic structural diagram of a temperature sensor in FIG. 12 provided inside an experimental cavity.

FIG. 14 is a diagram of the relationship between a total energy of a system and an energy of each part.

FIG. 15 is a schematic diagram of the relationship among the temperature, the temperature gradient and various elements influencing the temperature and the temperature gradient.

FIG. 16 is a schematic diagram of a triaxial experiment.

FIG. 17 is a simplified diagram of a structure of a triaxial loading experimental device according to an embodiment of the present disclosure.

In the drawing: 100—gas medium temperature adjusting assembly; 200—intermediate cavity assembly; 300—upper cover assembly; 400—lower cover assembly; 1—cavity assembly of a transmitting part; 2—neutron incident channel; 3—X-ray incident channel; 4—gas channel; 5—gas guide plate; 6—buckle; 7—cavity assembly of a receiving part; 8—neutron window channel; 9—X-ray window channel; 11—large slip ring; 12—small slip ring; 13—clamp channel; 14—tee; 1401—low-temperature nitrogen inlet; 1402—normal-temperature air inlet; 1403—tee exit; 15—heater; 1501—heater housing; 1502—heating pipe; 1503—heater outlet pipe; 16—inlet assembly; 17—one-way valve; 18—connecting pipe; 19—pneumatic quick-plug connector; 20—temperature sensor support frame; 21—temperature sensor; 22—gas processing and conveying device; 221—control module; 222—liquid nitrogen tank; 223—air pump; 224—gas source; 225—gas input pipe; 226—air branch; 227—nitrogen branch; 228—experimental cavity; 2101—first temperature sensor; 2102—second temperature sensor; 2103—third temperature sensor; 2104 fourth temperature sensor; 2105—fifth temperature sensor; 2106—sixth temperature sensor; 101—clamp; 102—sample.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without paying creative labor belong to the scope of protection of the present disclosure.

In order to make the above objectives, features and advantages of the present disclosure more obvious and understandable, the present disclosure will be explained in further detail with reference to the drawings and the detailed description hereinafter.

In the present disclosure, the thermal balance means that the temperature in each part of the target area changes little and is in a basically balanced state, or that the temperature fluctuation range does not exceed 3 degrees Celsius.

According to the research of the inventors, it is found that the traditional experimental methods directly control the temperature of the ambient temperature in the experimental cavity by means of resistance wires and liquid nitrogen, so that it is difficult to achieve precise temperature control, uniform temperature field distribution and continuous temperature change from high temperature to low temperature and from low temperature to high temperature. The reasons are as follows. 1. The heating and cooling systems are separated. In the traditional technology, resistance wires are heated and liquid nitrogen is cooled usually by independent systems. The physical mechanisms are different from each other (resistance wires heat up through the Joule effect, while liquid nitrogen cools down by absorbing heat during phase change), which results in energy transfer delay and inconsistent control when switching between the cooling process and the heating process. 2. The temperature field is not uniform enough, and the local heat/cold sources are concentrated: resistance wires and liquid nitrogen nozzles are usually distributed in points or lines, and the heat/cold diffusion depends on the thermal conductivity of the material itself, which easily leads to a large temperature gradient and is difficult to form a uniform field. Therefore, when the performance of materials and structures under the multi-field coupling condition is deeply studied, it is necessary to simulate the environmental changes in actual working conditions more accurately, which requires a device and a method with simple structure, high-precise temperature control, uniform temperature field distribution and continuous temperature change to promote experiments and research in related fields.

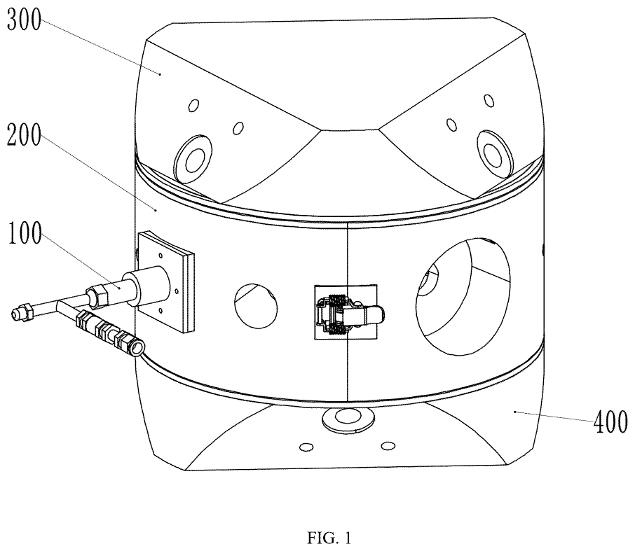

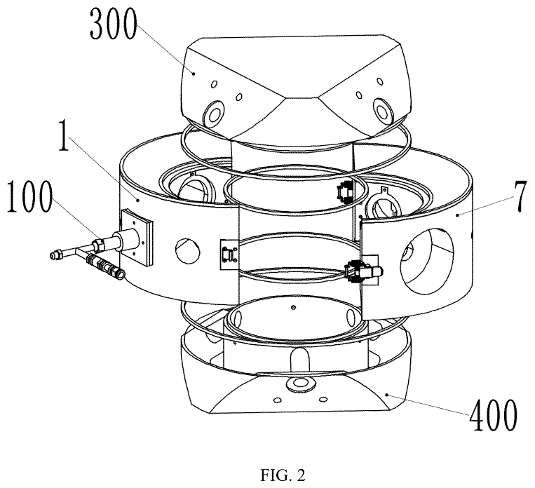

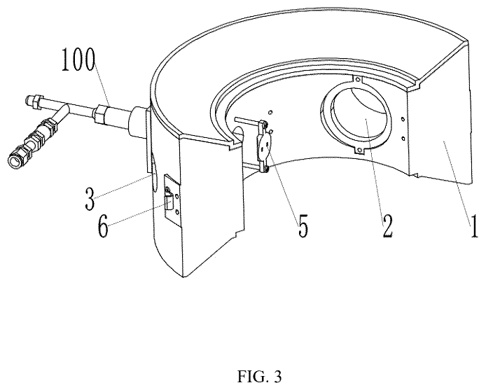

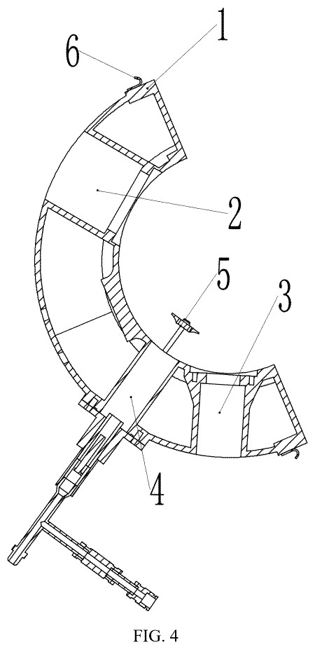

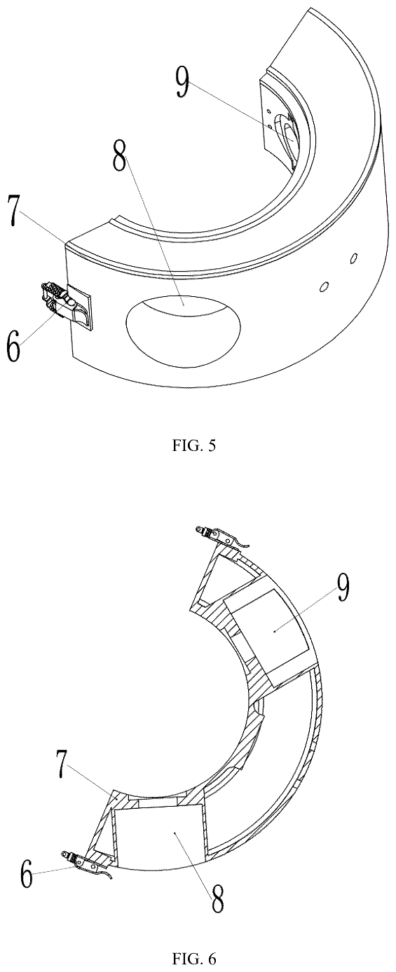

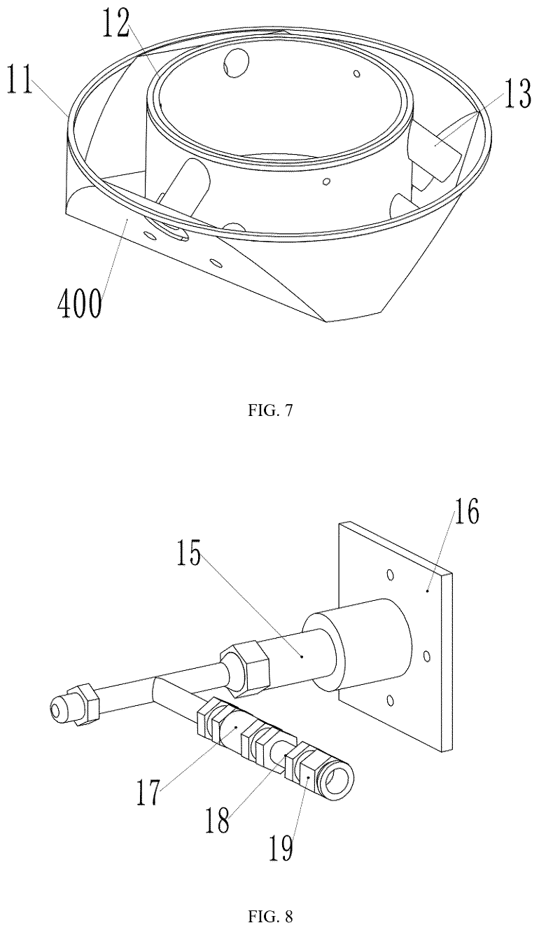

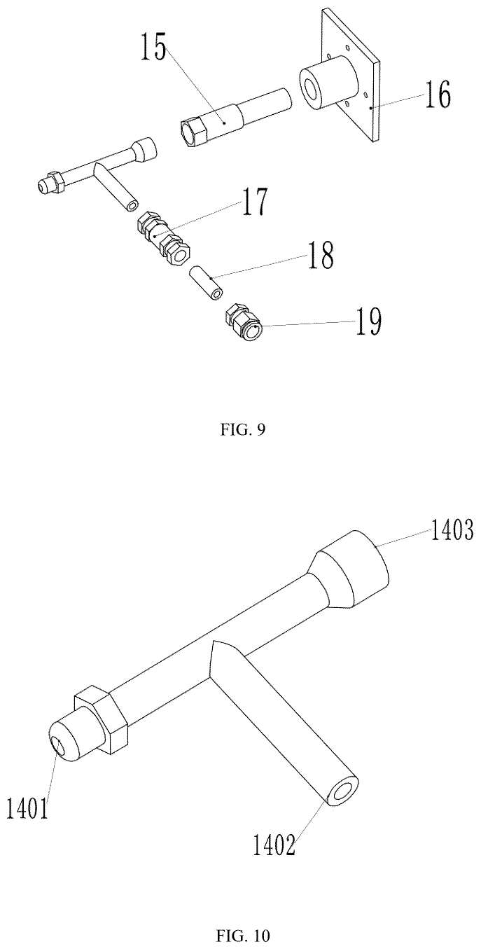

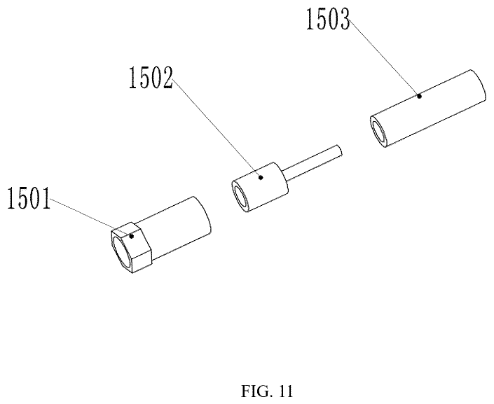

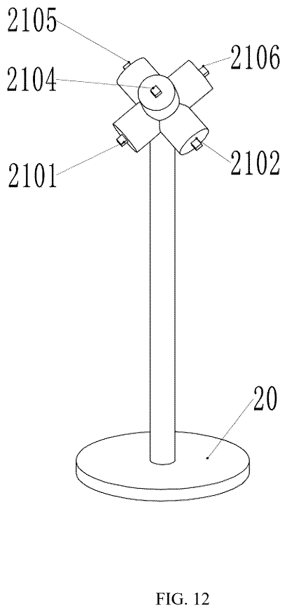

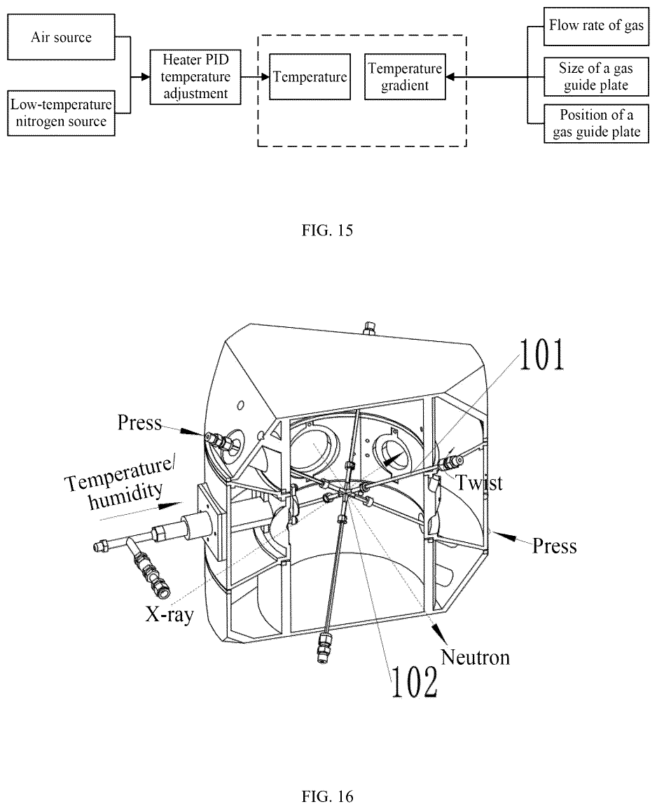

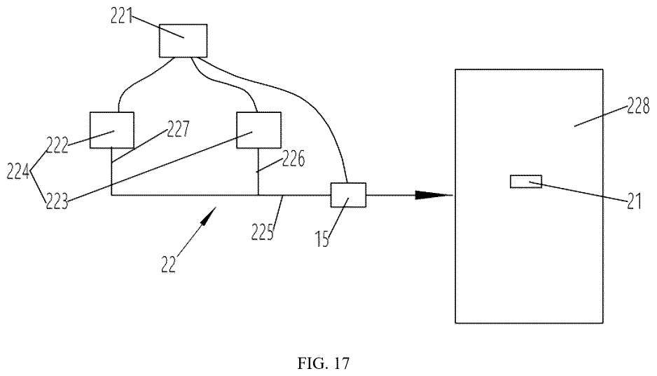

Embodiments of the present disclosure will be described with reference to FIG. 1 to FIG. 17 hereinafter.

### Embodiment 1

The present disclosure provides a temperature control device for a triaxial loading experiment, including: a gas processing and conveying device 22 and a control module 221. The gas processing and conveying device 22 is configured to heat a gas medium and input the processed gas medium into an experimental cavity 228. The control module 221 is communicated with the gas processing and conveying device 22, controls the gas processing and conveying device 22 to continuously input the gas medium for temperature adjustment into the experimental cavity 228, adjusts the temperature of the gas medium to allow a target area in the experimental cavity 228 to reach thermal balance, and then adjusts a flow rate of the input gas medium to allow a temperature gradient of the target area to reach a set threshold range.

According to the scheme provided by the present disclosure, the gas medium for temperature adjustment is input into the experimental cavity 228 to adjust the temperature of the experimental cavity 228. The gas medium input into the experimental cavity 228 is fast in diffusion speed and low in energy transfer delay under the action of the precursor force, so that the temperature gradient is small and the temperature is uniform. In addition, in the scheme provided by the present disclosure, both the temperature reduction and the temperature increase are achieved by the method of inputting the gas medium. The same device and control module 221 are used, so that the control process is consistent, the delay is low, the temperature adjustment efficiency and the quality are improved, and continuous temperature change is enabled.

In some embodiments, the gas processing and conveying device 22 includes a gas input pipe 225, a gas source 224 and a heater 15. An end of the gas input pipe 225 is communicated with the experimental cavity 228, and the other end thereof is communicated with the gas source 224. The heater 15 heats the gas medium before being input into the experimental cavity 228. The gas source 224 supplies the gas medium to the gas input pipe 225. The control module 221 is communicated with the heater 15 and the gas source 224 to control a heating power of the heater 15 and a supply flow rate of the gas source 224.

This embodiment achieves the functions of heating and conveying the gas medium.

In some embodiments, the gas sources comprises two gas sources 224, namely a liquid nitrogen tank 222 and an air pump 223. The liquid nitrogen tank 222 supplies low-temperature nitrogen to the gas input pipe 225, and the air pump 223 supplies normal-temperature air to the gas input pipe 225.

This embodiment can save energy or expand the temperature control range for the following reasons: in this embodiment, the initial temperature of air is different from that of nitrogen. The initial temperature of nitrogen after coming out of the liquid nitrogen tank 222 is usually in the range of −150° C. to −50° C., and the temperature of normal-temperature air is in the range of 20 to 40° C. Therefore, when the experimental cavity 228 needs high temperature, air is used as a gas medium, which is heated and then input into the experimental cavity 228. When the experimental cavity 228 needs low temperature, nitrogen is used as a gas medium, which is heated and then input into the experimental cavity 228. It can be understood that the purpose of heating nitrogen is to increase the temperature of low-temperature nitrogen, rather than mean that the heated nitrogen will increase the temperature of the experimental cavity 228, which may increase the temperature of the experimental cavity 228 or lower the temperature of the experimental cavity 228. On the one hand, this reduces the energy consumption of the heater 15. In order to facilitate understanding and comparison, the present disclosure further provides another example. In this embodiment, only one gas medium, namely low-temperature nitrogen, is provided, because cooperation of the low-temperature nitrogen and the heater 15 can meet a wider temperature range compared with air at normal temperature. Assuming that the initial temperature of the low-temperature nitrogen is-50 degrees Celsius, when the temperature in the experimental cavity 228 needs to reach 60 degrees Celsius, the power of the heater 15 needs to be increased to increase the low-temperature nitrogen from −50 degrees Celsius to 60 degrees Celsius or more. Therefore, compared with the embodiment of the present disclosure in which two gas media are provided, the embodiment using only low-temperature nitrogen as the gas medium will consume more electric energy.

The low temperature range can be in the range of “−80° C. to 40° C.” and the high temperature range can be in the range of “40° C. to 80° C.” without being limited to the above range.

In some examples, the temperature of nitrogen output from the liquid nitrogen tank 222 can be adjusted, which is the function of the liquid nitrogen tank 222, which will not be described in detail here in the present disclosure.

In some embodiments, the liquid nitrogen tank 222 is communicated with the gas input pipe 225 through a nitrogen branch 227. The air pump 223 is communicated with the gas input pipe 225 through an air branch 226. The air branch 226 is provided with a one-way valve 17. An exhaust port of the liquid nitrogen tank 222 or the nitrogen branch 227 is provided with an exhaust valve with adjustable opening. Both the air pump 223 and the exhaust valve are communicated with the control module 221.

This embodiment achieves the purpose of simultaneously connecting the liquid nitrogen tank 222 and the air pump 223 to the gas input pipe 225.

In some examples, the nitrogen branch 227, the gas input pipe 225 and the air branch 226 form a tee 14.

Specifically, the low-temperature nitrogen inlet 1401 of the tee 14 is provided with a thread, which can be connected with the liquid nitrogen tank 222 to provide low-temperature nitrogen to the experimental cavity 228. The normal-temperature air inlet 1402 of the tee 14 is connected and communicated with the one-way valve 17, the connecting pipe 18 and the pneumatic quick-plug connector 19 in sequence. The normal-temperature air inlet 1402 and the one-way valve 17, the one-way valve 17 and the connecting pipe 18, as well as the connecting pipe 18 and the pneumatic quick-plug connector 19 are all connected by sleeves. The tee outlet 1403 of the tee 14 is in threaded connection with the heater 15. A heating channel is provided in the heater 15. The gas medium outlet is communicated with the heating channel. The end of the heater 15 far away from the tee 14 is connected and communicated with an inlet assembly 16. The inlet assembly 16 is provided on the outer wall of the structural member (which encloses an experimental cavity 228, which is described in Embodiment 2).

The heater 15 includes a heater housing 1501, a heating pipe 1502, and a heater outlet pipe 1503. The heater housing 1501 is fixedly connected with the heating pipe 1502. The heater outlet pipe 1503 is connected with the heater housing 1501 through threads.

The tee 14 and the heater 15 form a gas medium temperature adjusting assembly 100.

In some embodiments, the embodiment of the present disclosure further includes a plurality of temperature sensors 21. The plurality of temperature sensors 21 are provided at different directions in the target area, respectively.

The temperature sensor 21 in this embodiment is configured to detect whether the target area reaches thermal balance and whether the temperature gradient reaches the set threshold range.

In some embodiments, the embodiment of the present disclosure further includes a gas guide plate 5. The gas guide plate 5 is provided in the experimental cavity 228 and opposite to an air inlet of the experimental cavity 228. A gap is provided between the gas guide plate 5 and the air inlet.

In this embodiment, after the gas medium enters the experimental cavity 228 from the gas input pipe 225 and the air inlet, the gas medium is immediately blocked by the gas guide plate 5, so that the gas medium flows along the wall of the experimental cavity 228 and gradually diffuses to the middle of the experimental cavity 228, that is, the target area. Therefore, in this embodiment, the gas guide plate 5 is provided to speed up the gas diffusion.

In some examples, in order to further improve the diffusion speed, the shape of the gas guide plate 5 can be optimized, for example, a gas guide surface is constructed on the end face of the gas guide plate 5 facing the air inlet, and the gas guide surface can guide the gas impinging on the gas guide plate 5 to the surrounding area.

In some examples, the gas guide plate 5 is detachably provided, which is convenient to change the size or shape of the gas guide plate 5 so that the scheme provided by the present disclosure can achieve the required temperature gradient.

In some embodiments, the control module 221 controls the power of the heater 15 according to a Proportional-Integral-Derivative (PID) temperature adjustment method. The PID temperature adjustment method is a conventional method, which will not be described in detail in the present disclosure.

### Embodiment 2

The present disclosure further provides a triaxial loading experimental device, including structural members enclosing an experimental cavity 228 and the temperature control device for the triaxial loading experiment as described above.

This embodiment has all the advantages of the above embodiments, which will not be described in detail here.

In some embodiments, the structural members include a middle cavity assembly 200, an upper cover assembly 300 and a lower cover assembly 400. The middle cavity assembly 200 is in a form of a sleeve structure with an upper opening and a lower opening. The upper cover assembly 300 is provided at the upper opening of the middle cavity assembly 200, and the lower cover assembly 400 is provided at the lower opening of the middle cavity assembly 200. The middle cavity assembly 200 is provided with a neutron incident channel 2, a neutron window channel 8, an X-ray incident channel 3, an X-ray window channel 9 and a gas channel 4. The lower cover assembly 400 and the upper cover assembly 300 each are provided with a clamp channel 13 communicating an inner side and an outer side. A triaxial loading clamp passes through the clamp channel 13. An upper end and a lower end of the middle cavity assembly 200 are in sliding contact with the lower cover assembly 400 and the upper cover assembly 300, respectively, so that the middle cavity assembly 200 is rotatable around its own axis. In this way, neutrons and X-rays can be incident around the sample, and the incident angle changes by the same angle each time, thus achieving three-dimensional reconstruction of the sample 102.

Specifically, the upper cover assembly 300 and the lower cover assembly 400 have the same structure. The installation angles of the upper cover assembly 300 and the lower cover assembly 400 are different from each other during installation. As shown in FIG. 1, the included angle between the upper cover assembly 300 and the lower cover assembly 400 in the horizontal direction is 60 degrees. The upper cover assembly 300 and the lower cover assembly 400 are fixedly provided in the use state, and the middle cavity assembly 200 is rotatable around its own axis.

Both the upper cover assembly 300 and the lower cover assembly 400 are in sliding contact with the middle cavity assembly 200 through slip rings. Specifically, since the middle cavity assembly 200, the upper cover assembly 300 and the lower cover assembly 400 all have an inner-layer structure and an outer-layer structure, the middle cavity assembly 200 is in sliding contact with the upper cover assembly 300 and the lower cover assembly 400 through the large slip ring 11 and the small slip ring 12.

In some embodiments, the intermediate cavity assembly 200 includes a connecting transmitting part cavity assembly 1 and a ray receiving part cavity assembly 7. The connecting transmitting part cavity assembly 1 and the ray receiving part cavity assembly 7 generally has a semi-circular arc structure. The connecting transmitting part cavity assembly 1 and the ray receiving part cavity assembly 7 are detachably connected by a buckle 6 provided on the outer wall.

In some embodiments, the neutron incident channel 2 is coaxial with the neutron window channel 8. The X-ray incident channel 3 is coaxial with the X-ray window channel 9. Moreover, the included angle between the neutron incident channel 2 and the X-ray incident channel 3 is 116.5°, and the included angle between the neutron window channel 8 and the X-ray window channel 9 is 116.5°.

In some embodiments, the middle cavity assembly 200, the upper cover assembly 300 and the lower cover assembly 400 are all made of nylon 12 (“12” here is not the reference numeral “12”, but the name of a material together with “nylon”). The Nylon 12 has a low heat capacity and a fast temperature response speed, which is convenient to have a fast increase of the temperature of the experimental cavity 228. Different from the existing scheme that the wall surface of the cavity is made of metal, the metal material has a high heat capacity and a slow temperature response, which is not conducive to a fast increase of the temperature of the experimental cavity 228. This embodiment just solves this problem.

In some embodiments, the inner-layer structure of the intermediate cavity assembly 200 is a three-layer nested cylindrical wall.

### Embodiment 3

The present disclosure further provides a temperature control method for a triaxial loading experimental cavity, including:

continuously inputting a gas medium for temperature adjustment into an experimental cavity 228, adjusting the temperature of the gas medium to allow a target area in the experimental cavity 228 to reach thermal balance, and then adjusting a flow rate of the input gas medium to allow a temperature gradient of the target area to reach a set threshold range.

According to the scheme provided by the present disclosure, the gas medium for temperature adjustment is input into the experimental cavity 228 to adjust the temperature of the experimental cavity 228. The gas medium input into the experimental cavity 228 is fast in diffusion speed and low in energy transfer delay under the action of the precursor force, so that the temperature gradient is small and the temperature is uniform. In addition, in the scheme provided by the present disclosure, both the temperature reduction and the temperature increase are achieved by the method of inputting the gas medium. The same device and control module 221 are used, so that the control process is consistent, the delay is low, the temperature adjustment efficiency and the quality are improved, and continuous temperature change is enabled.

In some embodiments, the method includes a step of calibrating a temperature gradient in a cavity: providing six temperature sensors 21 in a target area, supporting the six temperature sensors 21 by the temperature sensor support frame 20 and arranging the six temperature sensors in six orientations, respectively; continuously inputting a gas medium for temperature adjustment into an experimental cavity 228, and adjusting the temperature of the gas medium to allow a target area in the experimental cavity 228 to reach thermal balance. At this time, the temperature values of the position where the six temperature sensors are located are measured. When the temperatures of the second temperature sensor 2102, the third temperature sensor 2103 and the sixth temperature sensor 2106 are high, it means that the gas flow rate is too fast along the cavity wall, and the gas flow rate should be reduced until the temperature gradient of the target area reaches the set threshold range, and the gas flow rate at this time is recorded as the first gas flow rate. The temperature gradient is determined by the readings of the six temperature sensors. Specifically, when the difference between the maximum values and the minimum values of the readings of the six temperature sensors are within 1° C., the gas flow rate at this time is recorded.

The method further includes a step of controlling the temperature precisely: continuously inputting a gas medium for temperature adjustment into an experimental cavity 228, adjusting the temperature of the gas medium to allow a target area in the experimental cavity 228 to reach thermal balance, and then adjusting a flow rate of the input gas medium to a first gas flow rate to allow a temperature gradient of the target area to reach a set threshold range. The specific step of controlling the temperature precisely is as follows. The set cavity temperature value is input into the control module 221. The control module 221 controls and adjusts the heating power of the heater 15 according to the PID temperature adjustment method. The original gas in the experimental cavity 228 is blown out with a large gas flow rate, and the cavity environment is heated or cooled, so that the cavity environment reaches a thermal balance. The flow rate of the gas medium is reduced to the first gas flow rate, wherein when the required temperature is low (−80° C. to 40° C.), a low-temperature nitrogen source should be used, and when the required temperature is high (40° C. to 80° C.), an air gas source should be used.

The method further includes a step of continuously changing the temperature from high temperature to low temperature: continuously inputting a gas medium for temperature adjustment into an experimental cavity 228, adjusting the temperature of the gas medium to allow a target area in the experimental cavity 228 to reach thermal balance, and then adjusting a flow rate of the input gas medium to a first gas flow rate to allow a temperature gradient of the target area to reach a set threshold range; wherein the gas medium in this step is nitrogen. The specific step of continuously changing the temperature from high temperature to low temperature is as follows. The temperature value of the cavity to be changed is input into the control module 221. The control module 221 first controls the air pump 223 to pump air with a large flow rate into the experimental cavity 228 to cool the heater 15 and prevent the heater 15 from being damaged by a large temperature shock. After the heater 15 is cooled, the control module 221 controls the air pump 223 to stop, and controls the liquid nitrogen tank 222 to input low-temperature nitrogen into the experimental cavity 228, so that the experimental cavity 228 is switched to a low temperature. After the cavity reaches thermal balance, it is only necessary to reduce the gas flow rate to the first gas flow rate.

The method further includes a step of continuously changing the temperature from low temperature to high temperature: continuously inputting a gas medium for temperature adjustment into an experimental cavity 228, adjusting the temperature of the gas medium to allow a target area in the experimental cavity 228 to reach thermal balance, and then adjusting a flow rate of the input gas medium to a first gas flow rate to allow a temperature gradient of the target area to reach a set threshold range; wherein the gas medium in this step is air. The specific step of continuously changing the temperature from low temperature to high temperature is as follows. The room temperature value is input into the temperature control program. The control module 221 judges the difference between the original temperature value in the low temperature state in the experimental cavity 228 and the room temperature value. When the difference is greater than a set threshold, for example, the temperature difference is greater than 20 degrees Celsius, the heater 15 is controlled to start to heat itself to prevent the heater 15 from being damaged by a large temperature shock. After the heater 15 is heated, air is input into the experimental cavity 228 from the pneumatic quick-plug connector 19. The experimental cavity is switched to high temperature, and the temperature value of the cavity to be changed is input into the temperature control program. After the cavity reaches thermal balance, it is only necessary to reduce the gas flow rate to the first gas flow rate.

This embodiment achieves the purpose of precise temperature control and continuous temperature change.

In some examples, the six temperature sensors in the step of calibrating the temperature gradient are provided in the target area through the support frame. It should be noted that only the step of calibrating the temperature gradient needs to provide the support frame and six temperature sensors separately. In the remaining steps, for example, in the step of controlling the temperature precisely, the temperature sensors are provided on the head of the clamp instead of providing the support frame, so that the temperature of the target area can also be detected. However, the sensor distribution is not as good as the position where six temperature sensors are arranged by using the support frame in the step of calibrating the temperature gradient. Therefore, before temperature control or experiment, it is necessary to use the step of calibrating the temperature gradient in the cavity to test whether the set temperature gradient can be reached at the required temperature and the standard gas flow rate when the temperature gradient under the set temperature is reached, so that the required temperature gradient can be reached by using the standard gas flow rate in the next temperature adjustment process. It can be understood that when experiments in a plurality of temperature fields are needed in an experiment, the step of calibrating the temperature gradient at a plurality of temperatures are needed to obtain a plurality of standard gas flow rates, so that the required temperature gradient can be reached by inputting the standard gas flow rate after the set temperature is reached in the subsequent temperature adjustment process.

In the present disclosure, the heater 15 is used to heat the gas medium. The heater 15 is operated by the control module 221. In order to improve the heating speed, the initial power value of the heater is calculated according to the following formula. When the temperature is close to the required temperature, the scheme is switched to the PID temperature adjustment scheme for control.

The calculation method of the power of the heater is as follows.

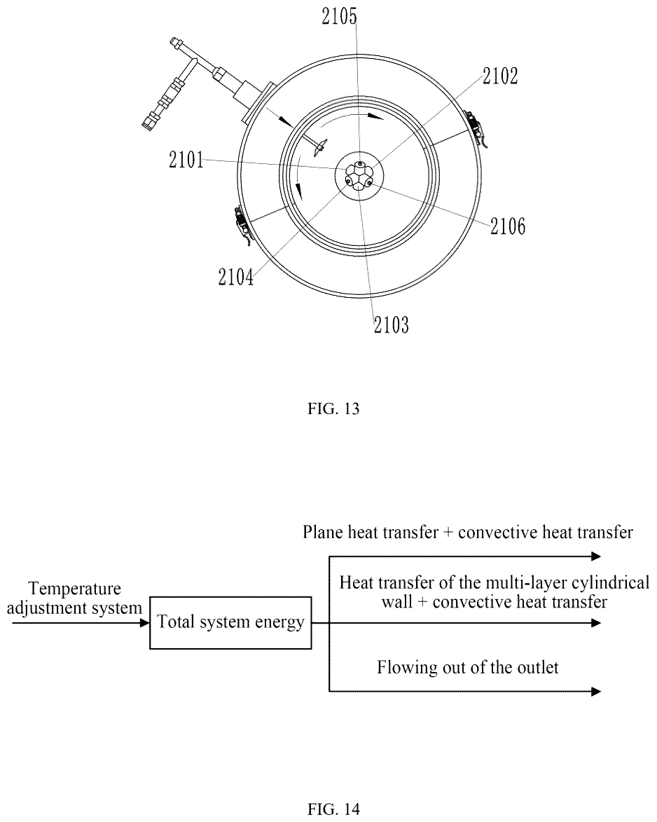

As shown in FIG. 13 and FIG. 14, the input energy of the system (that is, the work done by the heater) is related to the temperature and the quality of the input gas, and the calculation formula is as follows:

$$Q = cm Δ t \qquad ( 1 )$$

where Q denotes the input energy of the system, c denotes the specific heat capacity of the gas, m denotes the mass of gas, and Δt denotes the variation of temperature. The input power of the system is as follows:

$${Φ}_{input} = cm Δ {t}_{input} \qquad ( 2 )$$

where Φᵢₙₚᵤₜ denotes the input power of the system, c denotes the specific heat capacity of the input gas, m denotes the mass of the input gas in unit time, and Δtᵢₙₚᵤₜ denotes the difference between the input gas temperature and the room temperature due to heat exchange with the room temperature.

In the energy output of the system, the calculation formula of plane heat transfer is as follows:

$${Φ}_{plane} = \frac{Δ t}{{R}_{plane}} \qquad ( 3 )$$

where Rₚₗₐₙₑ denotes the thermal resistance of plane heat transfer, and Δt_{denotes} the difference between the internal environment and 26° C. The calculation formula of Rₚₗₐₙₑ is as follows:

$${R}_{plane} = \frac{δ}{{A}_{plane} {λ}_{plane}} \qquad ( 4 )$$

where δ denotes the plane thickness, Δₚₗₐₙₑ denotes the plane heat transfer area, and Δₚₗₐₙₑ denotes the plane thermal conductivity.

In the energy output of the system, the calculation formula of heat transfer of the multi-layer cylinder wall is as follows:

$${Φ}_{cylinderwall} = \frac{Δ t}{{R}_{cylinderwall}} \qquad ( 5 )$$

where R_{cylinderwall} denotes the thermal resistance of heat transfer of the multi-layer cylinder wall, and the calculation formula is as follows:

$${R}_{cylinderwall} = \frac{ln ( {d}_{2} / {d}_{1} )}{2 π l {λ}_{1}} + \frac{ln ( {d}_{3} / {d}_{2} )}{2 π l {λ}_{2}} + \frac{ln ( {d}_{4} / {d}_{3} )}{2 π l {λ}_{3}} \qquad ( 6 )$$

where λ₁, λ₂ and λ₃ denote the thermal conductivity of a one-layer cylinder wall, a two-layer cylinder wall and a three-layer cylinder wall, respectively; d₁, d₂ and d₃ denote the inner diameters of a one-layer cylinder wall, a two-layer cylinder wall and a three-layer cylinder wall, respectively; d₄ denotes the outer diameter of a three-layer cylinder wall; and 1 denotes the height of the cylinder wall.

In the energy output of the system, the calculation formula of the gas flowing out of the outlet is as follows:

$${Φ}_{outlet} = cm Δ t \qquad ( 7 )$$

where λₒᵤₜₗₑₜ denotes the output power of the gas flowing out of the outlet.

In the energy output of the system, the calculation formula of convective heat transfer is as follows:

$${Φ}_{convection} = \frac{Δ t}{{R}_{convection}} \qquad ( 8 )$$

where R_{convection} denotes the thermal resistance of convective heat transfer, and the calculation formula is as follows:

$${R}_{convection} = \frac{1}{{A}_{convection} h} \qquad ( 9 )$$

where Δₚₗₐₙₑ denotes the convective heat transfer area, and h denotes the convective heat transfer coefficient.

According to Formula (3), (5), (7) and (8), the calculation formula of the output power is as follows:

$${Φ}_{output} = \frac{Δ t}{{R}_{output}} + {Φ}_{outlet} \qquad ( 10 )$$

where R output denotes the total thermal resistance of heat transfer of the system, and the calculation formula is as follows:

$$\frac{1}{{R}_{output}} = \frac{1}{{R}_{plane} + {R}_{convection}} + \frac{1}{{R}_{cylinder wall} + {R}_{convection}} \qquad ( 11 )$$

According to the law of conservation of energy, Formula (2) to Formula (10) are combined to solve the input power Φᵢₙₚᵤₜ and the power of the heater.

When controlling the heater, in order to improve the control speed of the device, the Φᵢₙₚᵤₜ obtained through the above calculation is used as the power value for preliminary control. When the temperature reaches ±4° C. of the required temperature, the scheme is switched to the PID for control. At the same time, in order to solve the cumulative integral error in the PID control, Φᵢₙₚᵤₜ is used to strictly restrict the actual power of the heater. The actual power range of the PID control heater is the value of Φᵢₙₚᵤₜ=10 watts.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the detailed description and the application scope for those skilled in the art. To sum up, the contents of the specification should not be construed as limiting the present disclosure.

What is claimed is:

1. A temperature control device for a triaxial loading experiment, comprising:
a gas processing and conveying device, which is configured to heat a gas medium and input the processed gas medium into an experimental cavity; and
a control module, which is communicated with the gas processing and conveying device, controls the gas processing and conveying device to continuously input the gas medium for temperature adjustment into the experimental cavity, adjusts the temperature of the gas medium to allow a target area in the experimental cavity to reach thermal balance, and then adjusts a flow rate of the input gas medium to allow a temperature gradient of the target area to reach a set threshold range.

2. The temperature control device for the triaxial loading experiment according to claim 1, wherein the gas processing and conveying device comprises a gas input pipe, gas sources and a heater, an end of the gas input pipe is communicated with the experimental cavity, and another end thereof is communicated with the gas source, the heater heats the gas medium before being input into the experimental cavity, the gas source supplies the gas medium to the gas input pipe, and the control module is communicated with the heater and the gas source to control a heating power of the heater and a supply flow rate of the gas source.

3. The temperature control device for the triaxial loading experiment according to claim 2, wherein the gas sources comprises two gas sources, namely a liquid nitrogen tank and an air pump, the liquid nitrogen tank supplies low-temperature nitrogen to the gas input pipe, and the air pump supplies normal-temperature air to the gas input pipe.

4. The temperature control device for the triaxial loading experiment according to claim 3, wherein the liquid nitrogen tank is communicated with the gas input pipe through a nitrogen branch, the air pump is communicated with the gas input pipe through an air branch, the air branch is provided with a one-way valve, an exhaust port of the liquid nitrogen tank or the nitrogen branch is provided with an exhaust valve with adjustable opening, and both the air pump and the exhaust valve are communicated with the control module.

5. The temperature control device for the triaxial loading experiment according to claim 3, further comprising a plurality of temperature sensors, wherein the plurality of temperature sensors are provided at different directions in the target area, respectively.

6. The temperature control device for the triaxial loading experiment according to claim 3, further comprising a gas guide plate, wherein the gas guide plate is provided in the experimental cavity and opposite to an air inlet of the experimental cavity, and a gap is provided between the gas guide plate and the air inlet.

7. A triaxial loading experimental device, comprising structural members enclosing an experimental cavity and the temperature control device for the triaxial loading experiment according to claim 1.

8. The triaxial loading experimental device according to claim 7, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

9. The triaxial loading experimental device according to claim 7, wherein the gas processing and conveying device comprises a gas input pipe, gas sources and a heater, an end of the gas input pipe is communicated with the experimental cavity, and another end thereof is communicated with the gas source, the heater heats the gas medium before being input into the experimental cavity, the gas source supplies the gas medium to the gas input pipe, and the control module is communicated with the heater and the gas source to control a heating power of the heater and a supply flow rate of the gas source.

10. The triaxial loading experimental device according to claim 9, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

11. The triaxial loading experimental device according to claim 9, wherein the gas sources comprises two gas sources, namely a liquid nitrogen tank and an air pump, the liquid nitrogen tank supplies low-temperature nitrogen to the gas input pipe, and the air pump supplies normal-temperature air to the gas input pipe.

12. The triaxial loading experimental device according to claim 11, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

13. The triaxial loading experimental device according to claim 11, wherein the liquid nitrogen tank is communicated with the gas input pipe through a nitrogen branch, the air pump is communicated with the gas input pipe through an air branch, the air branch is provided with a one-way valve, an exhaust port of the liquid nitrogen tank or the nitrogen branch is provided with an exhaust valve with adjustable opening, and both the air pump and the exhaust valve are communicated with the control module.

14. The triaxial loading experimental device according to claim 13, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

15. The triaxial loading experimental device according to claim 11, further comprising a plurality of temperature sensors, wherein the plurality of temperature sensors are provided at different directions in the target area, respectively.

16. The triaxial loading experimental device according to claim 15, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

17. The triaxial loading experimental device according to claim 11, further comprising a gas guide plate, wherein the gas guide plate is provided in the experimental cavity and opposite to an air inlet of the experimental cavity, and a gap is provided between the gas guide plate and the air inlet.

18. The triaxial loading experimental device according to claim 17, wherein the structural members comprise a middle cavity assembly, an upper cover assembly and a lower cover assembly; the middle cavity assembly is in a form of a sleeve-like structure with an upper opening and a lower opening, the upper cover assembly is provided at the upper opening of the middle cavity assembly, and the lower cover assembly is provided at the lower opening of the middle cavity assembly; the middle cavity assembly is provided with a neutron incident channel, a neutron window channel, an X-ray incident channel, an X-ray window channel and a gas channel, the lower cover assembly and the upper cover assembly each are provided with a clamp channel communicating an inner side and an outer side, a triaxial loading clamp passes through the clamp channel, and an upper end and a lower end of the middle cavity assembly are in sliding contact with the lower cover assembly and the upper cover assembly, respectively, so that the middle cavity assembly is rotatable around its own axis.

19. A temperature control method for a triaxial loading experimental cavity, comprising:
continuously inputting a gas medium for temperature adjustment into an experimental cavity, adjusting the temperature of the gas medium to allow a target area in the experimental cavity to reach thermal balance, and then adjusting a flow rate of the input gas medium to allow a temperature gradient of the target area to reach a set threshold range.

20. The temperature control method for the triaxial loading experimental cavity according to claim 19, comprising:
a step of calibrating a temperature gradient in a cavity: providing six temperature sensors in a target area, and arranging the six temperature sensors in six orientations, respectively; continuously inputting a gas medium for temperature adjustment into an experimental cavity, adjusting the temperature of the gas medium to allow a target area in the experimental cavity to reach thermal balance, and then adjusting a flow rate of the input gas medium to allow a temperature gradient of the target area to reach a set threshold range, and recording the gas flow rate at this time as a first gas flow rate;
a step of controlling the temperature precisely: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range;
a step of continuously changing the temperature from high temperature to low temperature: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range; wherein the gas medium in this step is nitrogen;
a step of continuously changing the temperature from low temperature to high temperature: continuously inputting a gas medium for temperature adjustment into an experimental cavity, adjusting the temperature of the gas medium to allow a target area in the experimental cavity to reach thermal balance, and then adjusting a flow rate of the input gas medium to a first gas flow rate to allow a temperature gradient of the target area to reach a set threshold range; wherein the gas medium in this step is air.
